(19) United States
(12) Patent Application Publication
(10) Pub. No.: US 2025/0111637 A1
(43) Pub. Date: Apr. 3, 2025

(54) METHOD AND APPARATUS TO ORIENT, DETECT AND CLASSIFY ROTATED TEXT IN IMAGES

(71) Applicant: KONICA MINOLTA BUSINESS SOLUTIONS U.S.A., INC., Foster City, CA (US)

(72) Inventor: Junchao WEI, San Mateo, CA (US)

(21) Appl. No.: 18/478,988

(22) Filed: Sep. 29, 2023

(51) Int. Cl. G06V 10/24; G06V 10/82; G06V 30/414

(52) U.S. Cl. CPC G06V 10/243; G06V 10/82; G06V 30/414

(57) ABSTRACT

A text location technique identifies printed characters, words, and sentences appearing at different orientations. Embodiments apply known skyline techniques in different rotational positions to train a deep learning system to recognize when text is at an orientation other than horizontal. The inventive technique is efficient in training deep learning systems to identify text.

### CROSS-REFERENCE TO RELATED APPLICATION

The present application is related to U.S. application Ser. No. 16/836,662, filed Mar. 31, 2020, now U.S. Pat. No. 11,270,146, entitled “Text Location Method and Apparatus”. The present application incorporates the entire disclosure of the just-referenced US Patent by reference.

### BACKGROUND OF THE INVENTION

The above-referenced US patent facilitates Intelligent Character Recognition (ICR) and Optical Character Recognition (OCR) of handwritten text, which can appear in many different variations. It would be desirable to provide a deep learning based solution that facilitates ICR and OCR of text—not only handwritten text but also text more generally—that appears at different orientations, angles, and/or perspectives, and not just on a horizontal line or as upright lines of text.

### SUMMARY OF THE INVENTION

Aspects of the present invention provide an orientation and rotation technique, which can handle OCR and ICR issues such as arbitrary orientation of lettering and handwritten text, including text appearing in natural scenes. Embodiments according to aspects of the present invention take advantage of the skyline techniques that the above-referenced US patent describes to determine orientation, and performs OCR and ICR on rotated text accordingly.

### BRIEF DESCRIPTION OF THE DRAWINGS

FIG. 1 is a high level diagram of process flow according to an embodiment;

FIG. 2 is a high level flow chart according to an embodiment;

FIG. 3 is a high level diagram of exemplary neural network structure according to an embodiment;

FIG. 4 is a high level diagram of exemplary neural network structure according to an embodiment

FIG. 5 is a high level block diagram according to an embodiment;

FIG. 6 is a high level block diagram according to an embodiment;

FIG. 7 is a high level block diagram of portions of FIGS. 5 and 6 according to an embodiment;

FIG. 8 is a high level block diagram of portions of FIGS. 5 and 6 according to an embodiment;

FIG. 9 is a representation of orientation division;

FIG. 10 is a further representation of orientation division;

FIG. 11 is a high level diagram of process flow, with accompanying representations;

FIGS. 12-14 are exemplary pictures containing text to which one or more embodiments of the present invention have been applied; and

FIG. 15 is a diagram of a semantic network according to an embodiment.

### DETAILED DESCRIPTION

Embodiments according to aspects of the present invention address the prevalence of rotated text lines in natural images. There are times when such text lines are very close to each other, and the text may occur on different lines and/or may appear in different fonts. Artifacts in the text, such as dirt, discoloration, blurring, lack of focus, and irregular light also are accounted for in different embodiments. OCR systems and ICR systems operate on the assumption that text being input to such systems is oriented properly. However, as noted, frequently such is not the case with natural scenes. The arbitrariness of location and rotation of text in such scenes can result in overlapping of text. One aspect of implementation of embodiments according to the invention enables placement of bounding boxes around text without overlap. This is a problem for which the above-referenced US patent describes a solution. Embodiments according to the present invention implement a model that can provide estimates and determinations of rotations and orientations without having to output all possible degrees of rotation. In this fashion, natural scenes such as camera images, handwriting, advertisements, logos, engraved characters, and/or letters may be resolved reliably.

As ordinarily skilled artisans will appreciate, embodiments of the invention provide two stages of processing. One stage determines text location, and another stage determines text orientation.

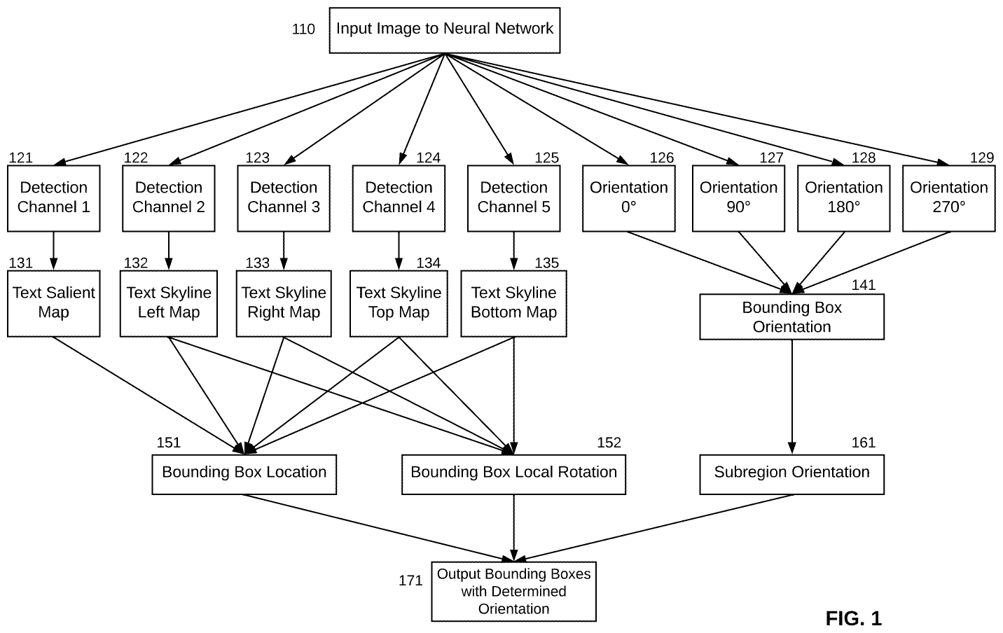

In FIG. 1, according to an embodiment, there are five channels to generate pixel-level segmentation maps to construct text kernels. In an embodiment, there are four more channels to generate orientations for bounding boxes and text.

At 110, an image may be input to a neural network, such as a convolutional neural network (CNN), a fully convolutional neural network (FCNN), or other suitable deep learning system. In an embodiment, the neural network is a Resnet backbone Fully Convolutional Network (FCN). In one aspect, the image that is input is a three-channel RGB color image. Five detection channels 121-125 receive the image. Detection channel 1 (121) outputs a text salient map at 131. In an embodiment, a text salient map may be a plurality of areas, each area covering an entire word. In devising the text salient map, the trained neural network takes advantage of a skyline appearance of each word, which covers a certain amount of territory on a printed page. Drawing a text salient map around a word's detected skyline thus will cover the entire word.

Each of detection channels 122-125 outputs a boundary for a different respective side of a detected skyline at 132-135, respectively. In an embodiment, detection channel 122 outputs a boundary of a left side of the skyline at 132, referred to as a skyline left map; detection channel 123 outputs a boundary of a right side of the skyline at 133, referred to as a skyline right map; detection channel 124 outputs a boundary of a top of the skyline at 134, referred to as a skyline top map; and detection channel 125 outputs a boundary of a bottom of the skyline at 135, referred to as a skyline bottom map.

The outputs from 131-135 are provided to determine bounding box location at 151. The outputs from 132-135 also are provided to determine a location rotation of bounding boxes at 152.

As discussed in the above-referenced US patent, in an embodiment, the different map portions may be output to a map composition section (not shown), which puts together a salient map and the individual maps to generate a bounding box for each word.

In an embodiment, aspects of the invention address situations with overlapping text, and therefore of overlapping boundary boxes. In such circumstances, non-maximum suppression may be applied, to merge generated boundary boxes.

In an embodiment, there are four additional channels 126-129 which provide information on orientation at angles corresponding to positions on axes in an x-y plane. Moving counterclockwise around the axes, channel 126 provides information on orientation at 0°, corresponding to a normal, or flat, or horizontal orientation. Channel 127 provides information on orientation at 90°, corresponding to an orientation perpendicular to the 0° orientation. Channel 128 provides information on orientation at 180°, corresponding to an orientation that is inverted with respect to the 0° orientation. Channel 129 provides information on orientation at 270°, corresponding to an orientation that is inverted with respect to the 90° orientation.

Outputs of channels 126-129 are provided to provide information on bounding box orientation, at 141, for the various orientations that the respective channels handle. An output of bounding box orientation section 141 may be provided to a further orientation section 161, which handles subregions of text areas.

Outputs of bounding box location section 151, bounding box local rotation section 152, and subregion orientation section 161 may be provided to output bounding boxes for text, with determined orientation, at 171.

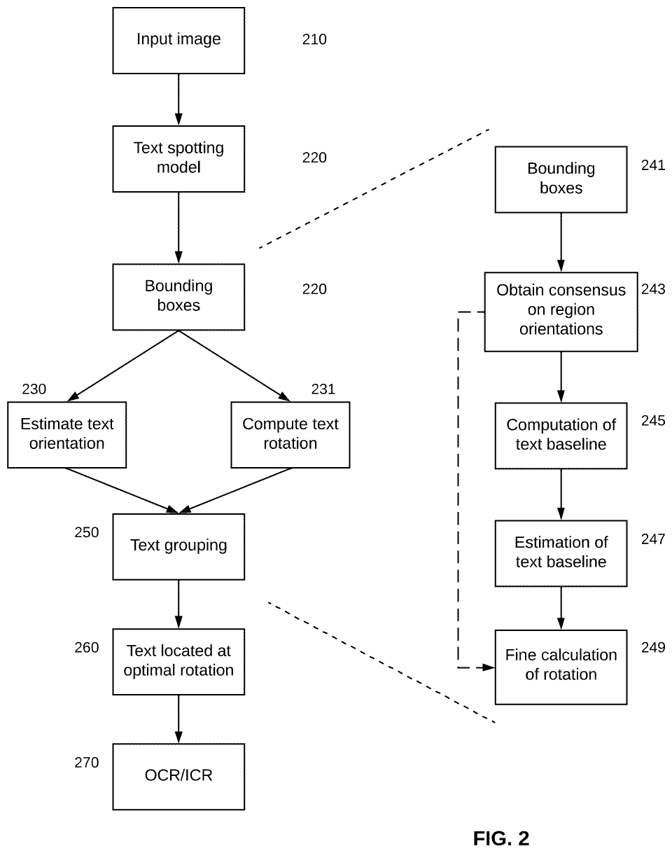

FIG. 2 shows a high level flow of operations according to embodiments. At 210, an image is input. At 220, a text spotting model, as described in the above-referenced US patent and as described herein, is applied to the input image, to spot the text in the image. At 220, bounding boxes are provided around the identified text. Text orientation is estimated at 230, and text rotation is computed at 231. Text then is grouped at 250.

The flow from the bounding box provision at 220 to the text grouping at 250 is shown in expanded form at the right of FIG. 2. After bounding boxes are formed at 241, a deep learning model to be described herein may be used to identify a consensus on orientation of regions of the input image, as at 243. Text baselines are computed and estimated at 245 and 247, respectively. Fine calculation of rotation is performed at 249, resulting in the text grouping at 250. Depending on the embodiment, consensus on region orientations at 243 can lead directly to rotation calculation at 249.

After the text is grouped, at 260 the text is rotated optimally to enable OCR and/or ICR to be performed at 270.

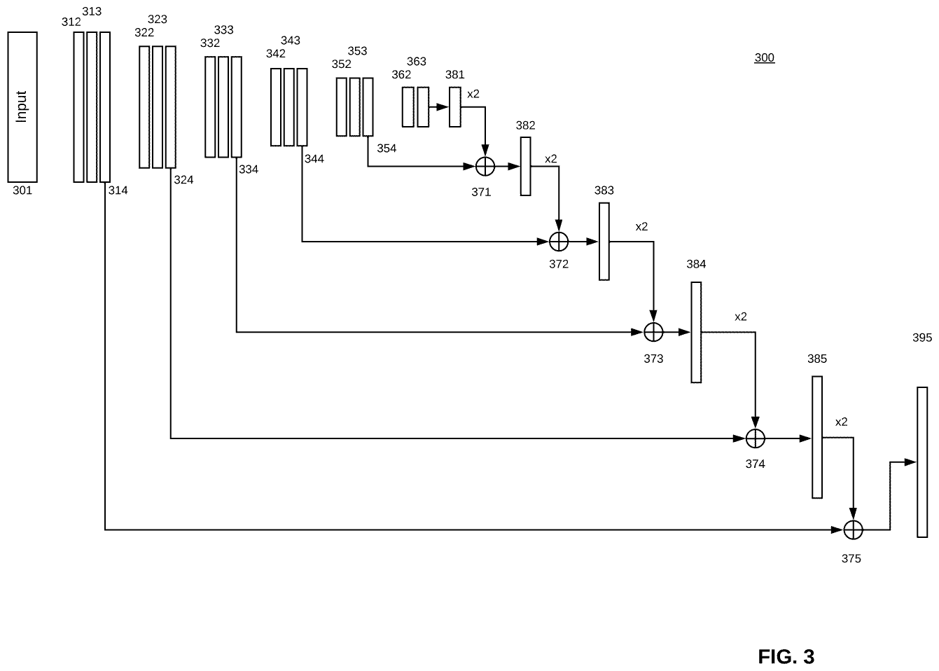

FIG. 3 shows an example of a Resnet backbone based fully convolutional network (FCN) 300 with connected intermediate layers, for the detection channels shown in FIG. 1. An image may be input at 301. Layers 312, 313; 322, 323; 332, 333; 342, 343; 352, 353; and 362, 363 are convolution layers within FCN 300. Layers 314, 324, 334, 344, and 354 are nonlinear layers within FCN 300. Layers 381-385 are intermediate, or deep layers.

At each nonlinear layer 314-354, there is a temporary output for merging an up-sampled feature map from a respective intermediate, or deep layer 381-385. The merged feature map becomes the intermediate layer for the next merge. The final outputs are five detected channels for the desired text features. Accordingly, in FIG. 3, at nonlinear layer 354, there is a temporary output for merging an up-sampled (×2) feature map from intermediate layer 381 at 371. At nonlinear layer 344, there is a temporary output for merging an up-sampled (×2) feature map from intermediate layer 382 at 372. At nonlinear layer 334, there is a temporary output for merging an up-sampled (×2) feature map from intermediate layer 383 at 373. At nonlinear layer 324, there is a temporary output for merging an up-sampled (×2) feature map from intermediate layer 384 at 374. Finally, at nonlinear layer 314, there is a temporary output for merging an up-sampled (×2) feature map from intermediate layer 385 at 375. The resulting output is a five channel detection layer 395, which has each of the five elements (salient map, left map, right map, top map, and bottom map) each word, for the generation of bounding boxes for each word.

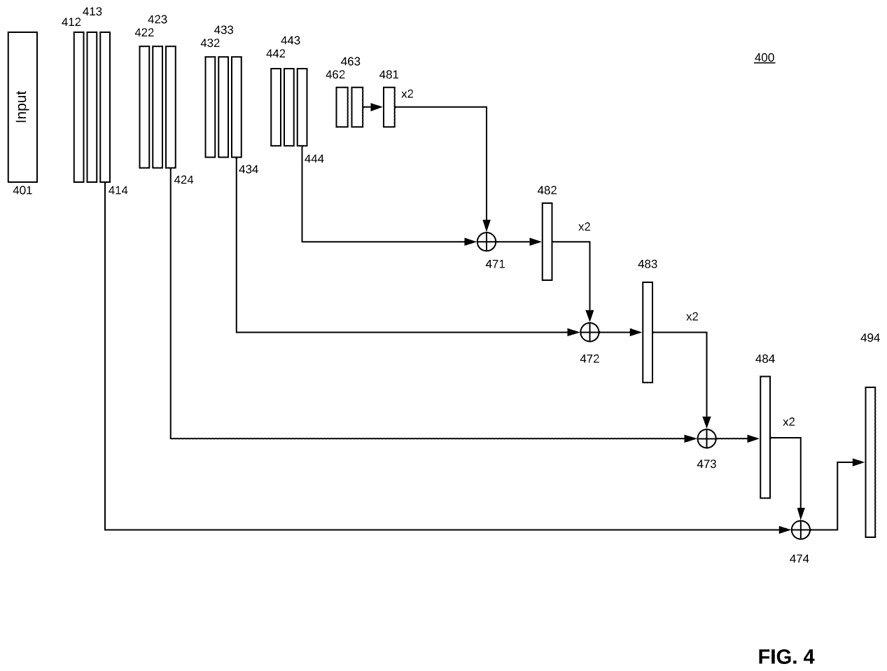

FIG. 4 shows an example of a Resnet backbone based fully convolutional network (FCN) 400 with connected intermediate layers, for the orientation channels shown in FIG. 1. An image may be input at 401. Layers 412, 413; 422, 423; 432, 433; 442, 443; and 462, 463 are convolution layers within FCN 400. Layers 414, 424, 434, and 444 are nonlinear layers within FCN 400. Layers 481-484 are intermediate, or deep layers.

At each nonlinear layer 414-444, there is a temporary output for merging an up-sampled feature map from a respective intermediate, or deep layer 481-484. The merged feature map becomes the intermediate layer for the next merge. The final outputs are five detected channels for the desired text features. Accordingly, in FIG. 4, at nonlinear layer 444, there is a temporary output for merging an up-sampled (×2) feature map from intermediate layer 481 at 471. At nonlinear layer 434, there is a temporary output for merging an up-sampled (×2) feature map from intermediate layer 482 at 472. At nonlinear layer 424, there is a temporary output for merging an up-sampled (×2) feature map from intermediate layer 483 at 473. Finally, at nonlinear layer 414, there is a temporary output for merging an up-sampled (×2) feature map from intermediate layer 484 at 474. The resulting output is a four channel detection layer 494, which has each of the four orientations (0°, 90°, 180°, and 270°) of each word, for the generation of bounding boxes for each word at appropriate orientations.

While FIGS. 3 and 4 show separate Resnet networks for determining bounding box location and bounding box orientation, respectively, according to an embodiment, ordinarily skilled artisans will appreciate that a single Resnet or other convolutional neural network with additional inputs and additional outputs, and corresponding additional intermediate layers as appropriate, may be used, with appropriately weighted nodes, to perform both bounding box location and bouncing box orientation. Ordinarily skilled artisans also will appreciate that the Resnet networks in FIGS. 3 and 4 may be trained separately with different training data or the same training data, or a single Resnet network may be trained with a corpus of training data that facilitates determination of text location and text orientation.

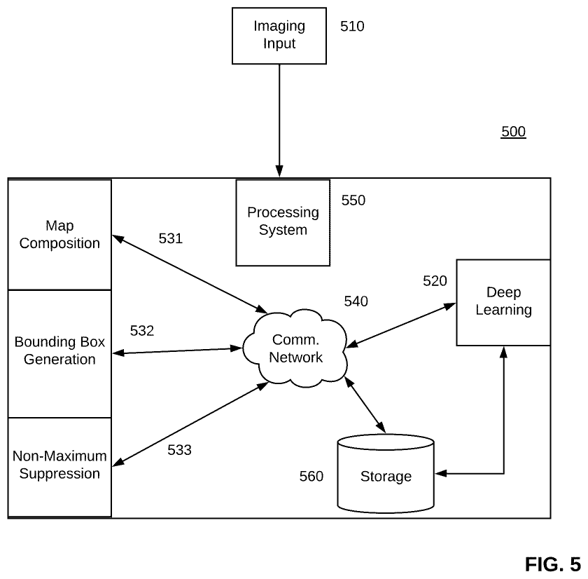

FIG. 5 is a high level block diagram of a computing system 500 which may implement a deep learning system 520, which in turn may be modeled on one or both of deep learning systems 300, 400, to perform stamp localization and text removal according to embodiments. Depending on the embodiment, imaging input 510 may have a library of images which can include training images as well as images which are to be processed. In an embodiment, imaging input 510 may include scanners, cameras, or other imaging equipment for scanning an invoice or other document as an input, and may provide training data for the deep learning system 520. Processing system 550 may be a separate system, or it may be part of imaging input 510, depending on the embodiment. Processing system 550 may include one or more processors, one or more storage devices, and one or more solid-state memory systems (which are different from the storage devices, and which may include both non-transitory and transitory memory).

In an embodiment, processing system 550 may include deep learning system 520 or may work with deep learning system to enable map composition block 531, bounding box generation block 532, and/or non-maximum suppression block 533 to perform text orientation depending on the embodiment. In other embodiments, map composition block 531, bounding box generation block 532, and/or non-maximum suppression block 533 may implement its own deep learning system 300, 400, or 520. In embodiments, each of map composition block 531, bounding box generation block 532, and/or non-maximum suppression block 533 may include one or more processors, one or more storage devices, and one or more solid-state memory systems (which are different from the storage devices, and which may include both non-transitory and transitory memory). In embodiments, additional storage 560 may be accessible to one or more of map composition block 531, bounding box generation block 532, and/or non-maximum suppression block 533 and processing system 550 over a communications network 740, which may be a wired or a wireless network or, in an embodiment, the cloud.

In an embodiment, storage 560 may contain training data for the one or more deep learning systems 300, 400, 520, and/or may contain orientation results. Storage 540 may store input images from imaging input 510, and/or may store images to be processed, and/or may store processed images with stamps or seals removed.

Where communications network 540 is a cloud system for communication, one or more portions of computing system 500 may be remote from other portions. In an embodiment, even where the various elements are co-located, network 540 may be cloud-based.

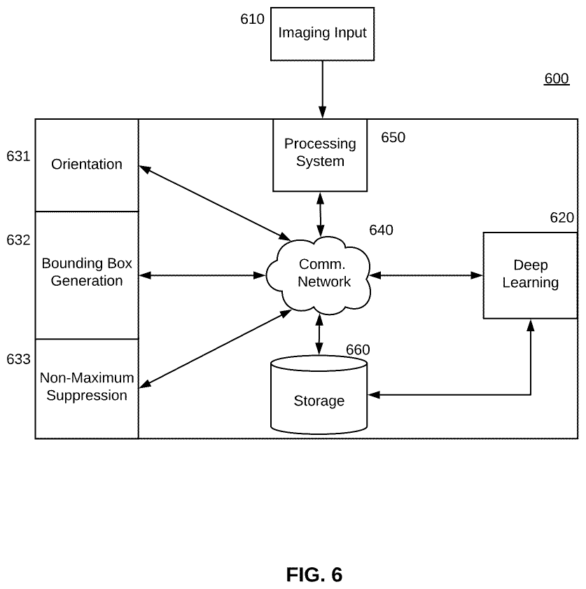

FIG. 6 is a high level block diagram of a computing system 600 which may implement a deep learning system 620, which in turn may be modeled on one or both of deep learning systems 300, 400, to perform stamp localization and text removal according to embodiments. Depending on the embodiment, imaging input 610 may have a library of images which can include training images as well as images which are to be processed. In an embodiment, imaging input 610 may include scanners, cameras, or other imaging equipment for scanning an invoice or other document as an input, and may provide training data for the deep learning system 620. Processing system 650 may be a separate system, or it may be part of imaging input 610, depending on the embodiment. Processing system 650 may include one or more processors, one or more storage devices, and one or more solid-state memory systems (which are different from the storage devices, and which may include both non-transitory and transitory memory).

In an embodiment, processing system 650 may include deep learning system 620 or may work with deep learning system to enable orientation block 631, bounding box generation block 632, and/or non-maximum suppression block 633 to perform text orientation depending on the embodiment. In other embodiments, orientation block 631, bounding box generation block 632, and/or non-maximum suppression block 633 may implement its own deep learning system 300, 400, or 620. In embodiments, each of orientation block 631, bounding box generation block 632, and/or non-maximum suppression block 633 may include one or more processors, one or more storage devices, and one or more solid-state memory systems (which are different from the storage devices, and which may include both non-transitory and transitory memory). In embodiments, additional storage 660 may be accessible to one or more of orientation block 631, bounding box generation block 632, and/or non-maximum suppression block 633 and processing system 650 over a communications network 640, which may be a wired or a wireless network or, in an embodiment, the cloud.

In an embodiment, storage 660 may contain training data for the one or more deep learning systems 300, 400, 620, and/or may contain orientation results. Storage 640 may store input images from imaging input 610, and/or may store images to be processed, and/or may store processed images with stamps or seals removed.

Where communications network 640 is a cloud system for communication, one or more portions of computing system 600 may be remote from other portions. In an embodiment, even where the various elements are co-located, network 640 may be cloud-based.

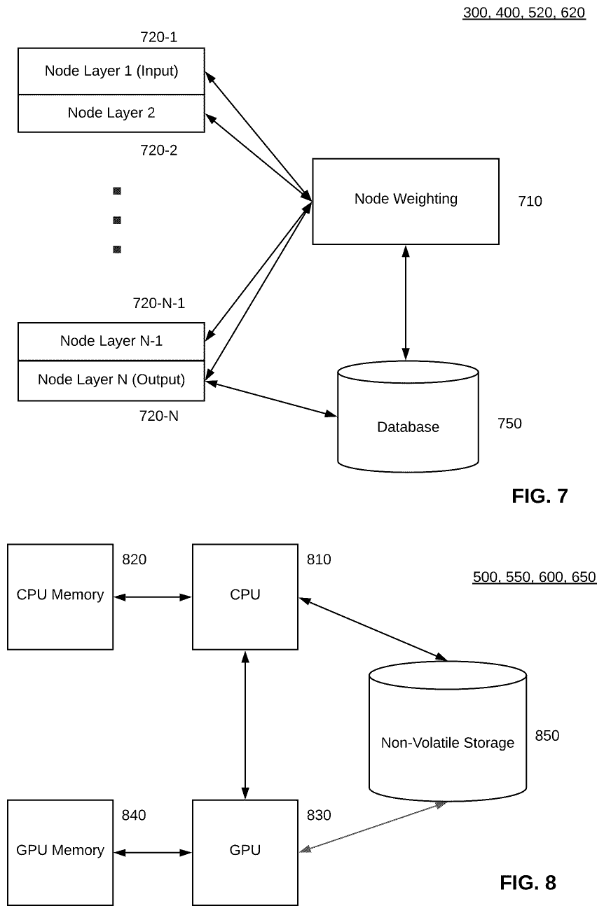

FIG. 7 is a high level diagram of apparatus for weighting of nodes in a deep learning system according to an embodiment. As training of a deep learning system proceeds according to an embodiment, the various node layers 720-1, . . . , 720-N may communicate with node weighting module 710, which calculates weights for the various nodes, and with database 750, which stores weights and data. As node weighting module 710 calculates updated weights, these may be stored in database 750.

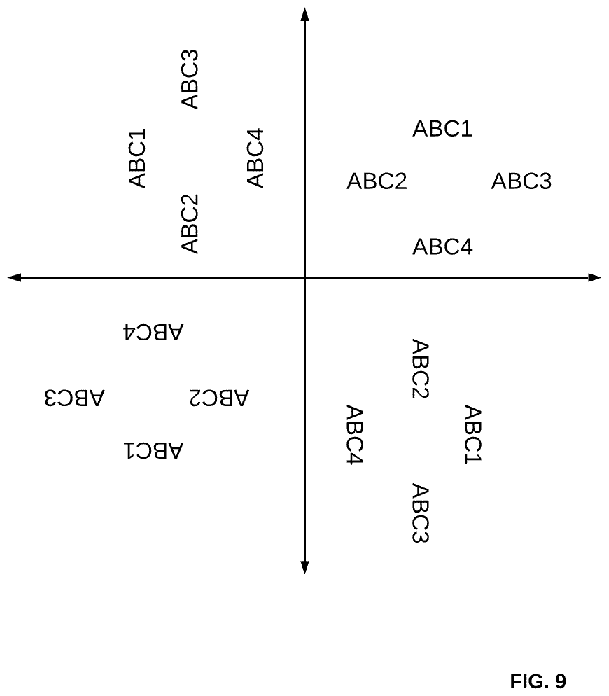

FIG. 8 is a high level diagram of apparatus to operate a deep learning system according to an embodiment. In FIG. 8, one or more CPUs 810 communicate with CPU memory 820 and non-volatile storage 850. One or more GPUs 830 communicate with GPU memory 840 and non-volatile storage 850. Generally speaking, a CPU may be understood to have a certain number of cores, each with a certain capability and capacity. A GPU may be understood to have a larger number of cores, in many cases a substantially larger number of cores than a CPU. In an embodiment, each of the GPU cores may have a lower capability and capacity than that of the CPU cores, but may perform specialized functions in the deep learning system, enabling the system to operate more quickly than if CPU cores were being used.

Depending on the embodiment, one or more of deep learning system 520, map composition block 531, bounding box generation block 532, non-maximum suppression block 533, processing system 550, deep learning system 620, orientation block 631, bounding box generation block 632, non-maximum suppression block 633, or processing system 650 may employ the apparatus shown in FIG. 8.

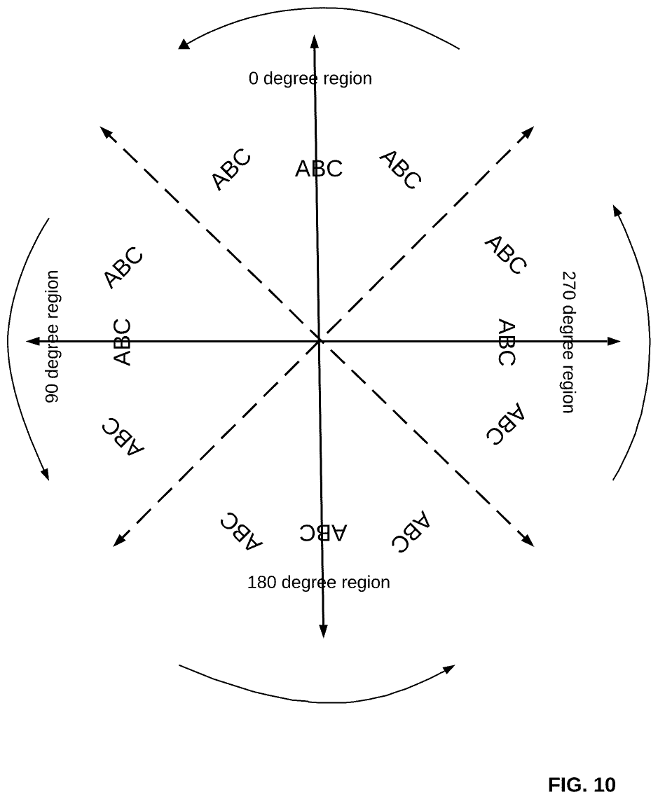

In an embodiment, instead of trying to account for all possible degrees of rotation of text, for training purposes different orientations of training data might be placed in different quadrants, as defined by, for example, x and y axes, as in FIG. 9. In FIG. 9, text with a normal orientation (0 degrees of rotation) may be placed in an upper right hand quadrant. Then, working counterclockwise, text working upwards vertically (90 degrees of rotation) may be placed in the upper left hand quadrant. Next, text that is inverted (180 degrees of rotation) may be placed in the lower left hand quadrant. Finally, text working downwards vertically (270 degrees of rotation) may be placed in the lower right hand quadrant.

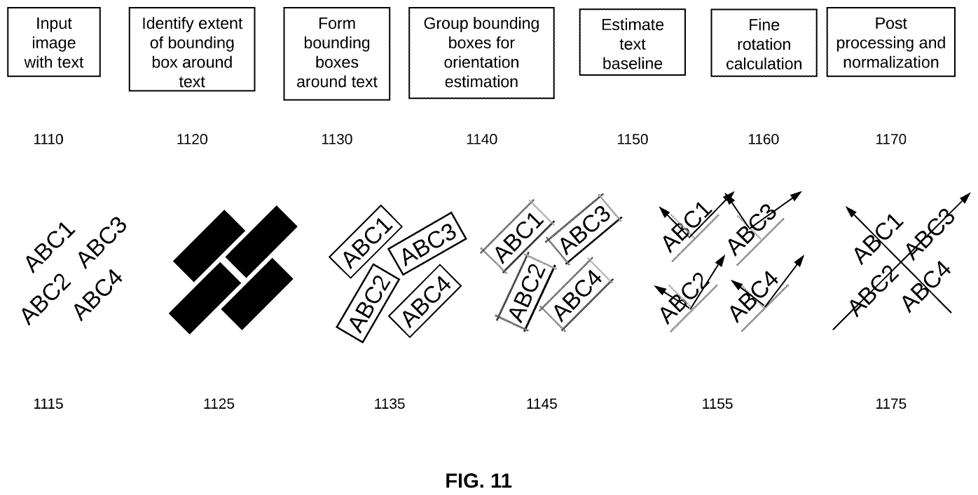

Next, in an embodiment the quadrants may be rotated by, for example, 45 degrees, as in FIG. 10. Rotation by 45 degrees provides symmetry with respect to the original x-y axes. Also, for text that would have an orientation putting it within a quadrant of the rotated axes, it is possible for the system to assess the orientation with respect to one or another quadrant of the original system. For example, looking at FIG. 10, text that would have an orientation putting it in an upper quadrant for the dotted coordinates (0 degrees, plus or minus 45 degrees), can be assessed relative to a region (0 degree region) that may include an orientation greater than 0 degrees, less than 0 degrees, or (if horizontally aligned) 0 degrees.

Looking at this further, a 90 degree region, a 180 degree region, and a 270 degree region may be defined. Text that would have an orientation placing the text in the 90 degree region could have an orientation of 90 degrees, plus or minus 45 degrees. Text that would have an orientation placing the text in the 180 degree region could have an orientation of 180 degrees, plus or minus 45 degrees. Text that would have an orientation placing the text in the 270 degree region could have an orientation of 270 degrees, plus or minus 45 degrees.

While a described embodiment shows four regions, a greater or lesser number of gradations would be possible, depending on the embodiment. For example, there could be 6 regions, from 0 to 360, but plus or minus 30 degrees instead of plus or minus 45 degrees. Alternatively, there could be nine regions, from 0 to 360, but plus or minus 22.5 degrees. Or there could be 12 regions, with each region being plus or minus 15 degrees. Training of systems with a greater number of regions may be more involved than training of a system with a smaller number of regions, but may process skewed or rotated text more quickly.

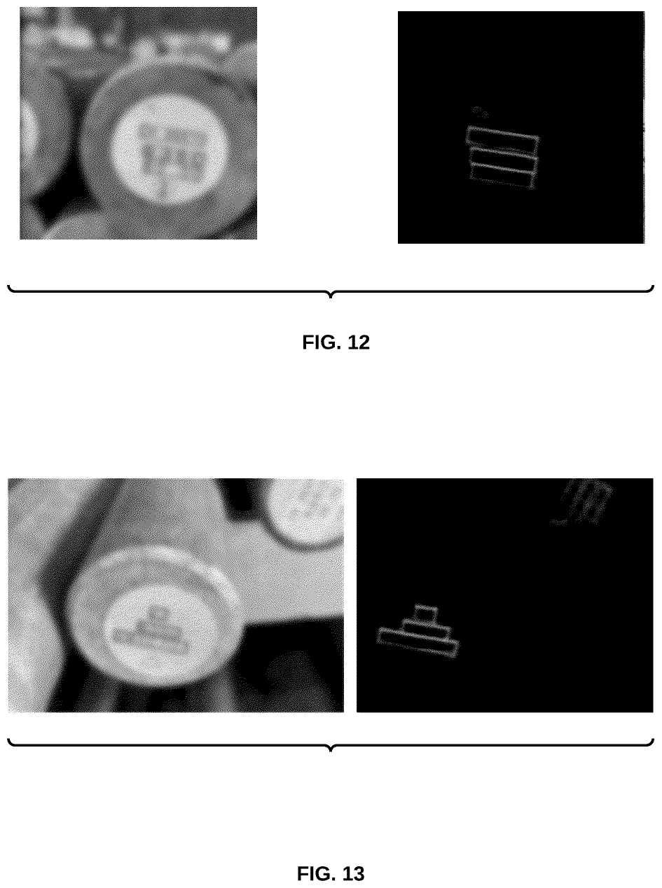

FIG. 11 shows a high level of flow for operation of a method and apparatus according to embodiments. At 1110, an image with text 1115 is input. At 1120, an extent of a bounding box 1125 around each piece of text is identified. At 1130, bounding boxes are formed around text, as shown at 1135. At 1140, the bounding boxes are grouped so that their orientation may be estimated, as shown at 1145. At 1150, text baseline is estimated, and at 1160, fine rotation is calculated, as shown at 1155. Finally, at 1170, post processing and normalization of the text, effectively locating the text relative to a pair of orthogonal axes, is performed, as shown at 1175.

In an embodiment, local region averaging and normalization may be used to improve identification of text orientations. Looking at this a little more closely, orientations of nearest bounding boxes form a group within a Euclidean distance d. When outliers of the group in terms of orientation are removed, the weighted average of the group orientation with the remaining bounding boxes can be updated for each text line.

In an embodiment, longer text lines to be processed can be assigned higher weights.

R_{xy}=Σᵢwᵢrᵢ Σᵢwᵢ=1
where
R_{xy} is the rotation in the x-y plane representing the group of bounding boxes
wᵢ represents the weights assigned for each text line
rᵢ represents the rotation for each text line

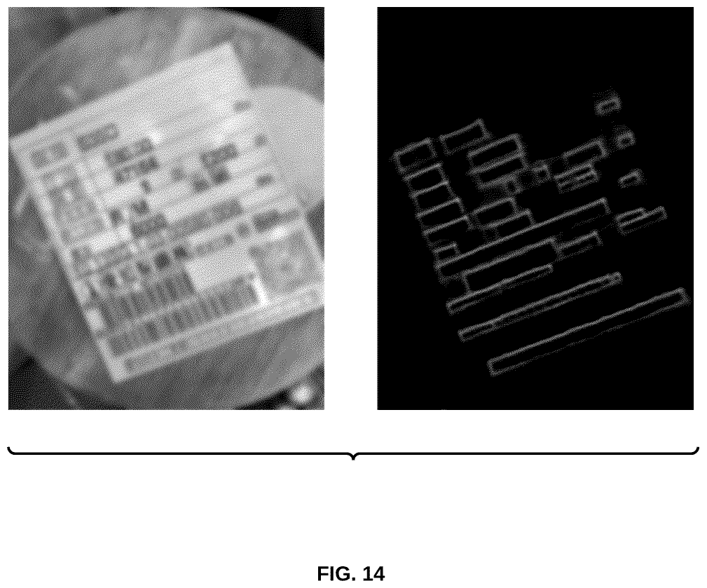

FIGS. 12-14 show examples of text occurring in natural scenes in different orientations. In each Figure, there is the natural scene, and bounding boxes for the text in the natural scene using baseline estimation according to an embodiment. In FIG. 12, text is shown on a label which is oriented at an angle so that the text is not horizontal. In FIG. 13, text is shown on a different label which likewise is oriented at an angle so that the text is not horizontal. FIG. 14 shows text at different orientations, with bounding boxes suitably around the text.

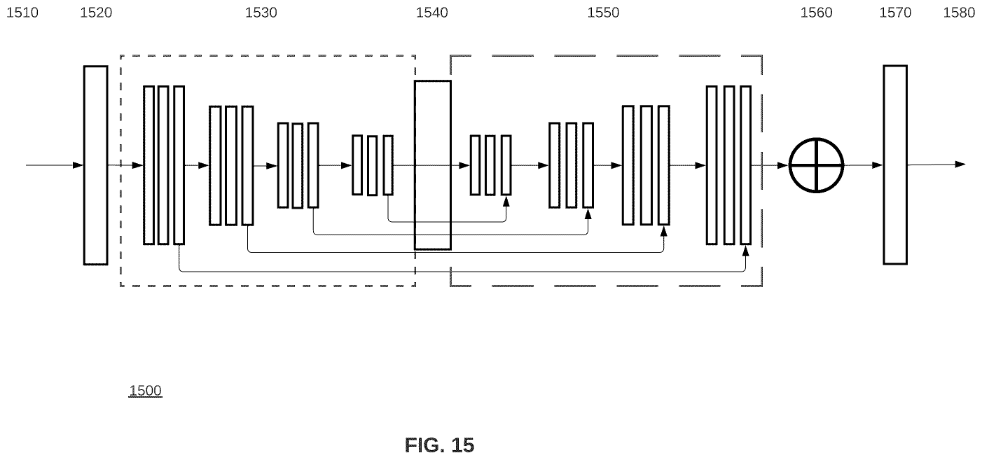

FIG. 15 is a high level diagram of a semantic network according to an embodiment. FIG. 15 may represent each of the networks in FIGS. 3 and 4, respectively, or FIG. 15 may represent an overall network performing the function of both networks. In FIG. 15, input image 1510 passes into input network 1520, which in an embodiment may be a tensor network. Encoder network 1530, which in an embodiment may be a convolutional neural network (CNN), in particular a Resnet network, receives the input from the input network 1520. Self-attention mechanism 1540 may receive an output of encoder network 1530, and may provide inputs to decoder network 1550. Summer 1560 may sum outputs of decoder network 1550 according to desired weighting of the outputs, and may provide an output to output network 1570, which also may be a tensor network depending on the embodiment, to yield output 1580.

In an embodiment, a self-attention mechanism based on CNN features may adjust learned weights in encoder network 1530 to provide greater weighting to more important features. In an embodiment, correlations among individual pixels may be calculated to enable the weight adjustment. In an embodiment, the self-attention mechanism may include an attention gate module, which can aggregate information from encoder network 1530 and upsampled information while adjusting the weights. In an embodiment, the network may utilize a set of implicit reverse attention modules and explicit edge attention guidance to establish a relationship between regions where stamps may be localized, and boundaries of the localized stamps.

In an embodiment, self-attention mechanism 1540 can obtain long-range feature information and adjust the weights of feature points by aggregating correlation information of global feature points. Although embodiments of self-attention mechanisms can improve the deep learning model's recognition accuracy, issues of excessive time, slow training speed, and/or excessively numerous weighting parameters may arise. One approach to reducing the amount of time is through use of tensor decomposition, in which higher rank tensors may be decomposed into linear combinations of lower-rank tensors. Thus, for example, input tensor network 1520 may have a rank of three, but output tensor network 1570 may have a rank of two.

Resnet networks can provide a large number of convolutional layers, in some cases, as many as thousands. Common numbers of layers in such networks are 18, 34, 50, 101, and 152. In an embodiment, as few as 18 convolutional layers may be satisfactory.

From the model output, there can be two main channel outputs according to an embodiment. A first channel outputs bounding box location. The second channel outputs bounding box orientation. Using the bounding box locations (1st channel), locate text. Then, using the bounding box orientations (2nd channel), it is possible to orient the text for OCR and/or ICR processing.

While the foregoing describes embodiments according to aspects of the invention, the invention is not to be considered as limited to those embodiments or aspects. Ordinarily skilled artisans will appreciate variants of the invention within the scope and spirit of the appended claims.

What is claimed is:

1. A method comprising:
inputting a text-containing document to a deep learning system having first and second pluralities of detection channels;
the first plurality of detection channels to locate text based on a skyline appearance of each word in the text-containing document;
using the deep learning system, providing first outputs of the first plurality of detection channels to generate a plurality of maps based on the skyline appearance;
using the deep learning system, generating a plurality of possible bounding box locations for each word of text using the generated maps;
the second plurality of detection channels to generate a plurality of possible orientations of said each word;
using the deep learning system, providing second outputs of the second plurality of detection channels to generate a plurality of possible bounding box orientations for said each word using the generated orientations; and
using the deep learning system, responsive to the generating the plurality of possible bounding box locations and the generating the plurality of possible bounding box orientations, generating a bounding box for said each word at a determined location with a determined orientation.

2. The method of claim 1, wherein the first plurality of detection channels comprises five first detection channels, and the providing first outputs comprises:
providing a first detection output as a text salient map covering said each word;
providing a second detection output as a text skyline left map at a lefthand portion of each word of text;
providing a third detection output as a text skyline right map at a righthand portion of each word of text;
providing a fourth detection output as a text skyline top map at a topmost portion of each word of text; and
providing a fifth detection output as a text skyline bottom map at a left portion of each word of text.

3. The method of claim 1, wherein the second plurality of detection channels comprises four second detection channels, the method further comprising:
providing a first bounding box orientation at 0 degrees with respect to a horizontal position of said each word;
providing a second bounding box orientation at 90 degrees with respect to the horizontal position of said each word;
providing a third bounding box orientation at 180 degrees with respect to the horizontal position of said each word;
providing a fourth bounding box orientation at 270 degrees with respect to the horizontal position of said each word; and
responsive to providing the first through fourth bounding box orientations, generating the plurality of possible bounding box orientations.

4. The method of claim 2, wherein the second plurality of detection channels comprises four second detection channels, the method further comprising:
providing a first bounding box orientation at 0 degrees with respect to a horizontal position of said each word;
providing a second bounding box orientation at 90 degrees with respect to the horizontal position of said each word;
providing a third bounding box orientation at 180 degrees with respect to the horizontal position of said each word;
providing a fourth bounding box orientation at 270 degrees with respect to the horizontal position of said each word; and
responsive to providing the first through fourth bounding box orientations, generating the plurality of possible bounding box orientations.

5. The method of claim 3, wherein the generating the plurality of possible bounding box locations further comprises:
combining the text salient map with the text skyline left map, the text skyline right map, the text skyline top map, and the text skyline bottom map, and with the word of text, to generate said each word with a remaining portion of the text salient map superimposed thereon;
determining a perimeter of the remaining portion of the text salient map; and
based on the text salient map, expanding the perimeter to generate the plurality of possible bounding box locations.

6. The method of claim 4, further comprising:
outputting a plurality of bounding boxes, each at a different respective confidence level, the method further comprising performing non-maximum suppression on each of the generated bounding boxes to facilitate combining of bounding boxes for adjacent or overlapping words; and
responsive to performing the non-maximum suppression, outputting a bounding box for said each word at the determined location.

7. The method of claim 5, further comprising:
responsive to generating the second through fifth detection outputs, outputting a preliminary orientation for each of the plurality of bounding boxes; and
responsive to the preliminary orientation, outputting the bounding box for said each word at the determined orientation and determined location.

8. The method of claim 3, further comprising:
responsive to providing said first through fourth bounding box orientations, combining the plurality of possible bounding box orientations with the preliminary orientation for said each word to output the bounding box at the determined orientation.

9. The method of claim 1, wherein the deep learning system comprises a neural network having a first plurality of convolution layers, a first plurality of nonlinear layers, a first plurality of intermediate layers, and at least one first detection layer, and wherein the providing the first outputs comprises, for said first pluralities of convolution layers, nonlinear layers, and intermediate layers and said at least one first detection layer:
merging an up-sampled feature map from a first intermediate layer and an output of a first nonlinear layer and providing a first merged result to a second intermediate layer;
merging an up-sampled feature map of the first merged result from the second intermediate layer and an output of a second nonlinear layer and providing a second merged result to the third intermediate layer;
merging an up-sampled feature map of the second merged result from the third intermediate layer and an output of a third nonlinear layer and providing a third merged result to the fourth intermediate layer;
merging an up-sampled feature map of the third merged result from the fourth intermediate layer and an output of a fourth nonlinear layer and providing a fourth merged result to the fifth intermediate layer; and
merging an up-sampled feature map of the fourth merged result from the fifth intermediate layer and an output of a fifth nonlinear layer and providing a fifth merged result to the detection layer.

10. The method of claim 9, wherein said neural network has a second plurality of convolution layers, a second plurality of nonlinear layers, a second plurality of intermediate layers, and at least one second detection layer, and wherein the providing the second outputs comprises, for said second pluralities of convolution layers, nonlinear layers, and intermediate layers and said at least one first detection layer:
merging an up-sampled orientation from a first intermediate layer and an output of a first nonlinear layer and providing a first merged result to a second intermediate layer;
merging an up-sampled orientation of the first merged result from the second intermediate layer and an output of a second nonlinear layer and providing a second merged result to the third intermediate layer;
merging an up-sampled orientation of the second merged result from the third intermediate layer and an output of a third nonlinear layer and providing a third merged result to the fourth intermediate layer; and
merging an up-sampled orientation of the third merged result from the fourth intermediate layer and an output of a fourth nonlinear layer and providing a fourth merged result to the detection layer.

11. An apparatus comprising:
at least one processor and a non-transitory memory that contains instructions that, when executed, enable the machine learning system to perform a method comprising:
inputting a text-containing document to a deep learning system having first and second pluralities of detection channels;
the first plurality of detection channels to locate text based on a skyline appearance of each word in the text-containing document;
using the deep learning system, providing first outputs of the first plurality of detection channels to generate a plurality of maps based on the skyline appearance;
using the deep learning system, generating a plurality of possible bounding box locations for each word of text using the generated maps;
the second plurality of detection channels to generate a plurality of possible orientations of said each word;
using the deep learning system, providing second outputs of the second plurality of detection channels to generate a plurality of possible bounding box orientations for said each word using the generated orientations; and
using the deep learning system, responsive to the generating the plurality of possible bounding box locations and the generating the plurality of possible bounding box orientations, generating a bounding box for said each word at a determined location with a determined orientation.

12. The apparatus of claim 11, wherein the first plurality of detection channels comprises five first detection channels, and the providing first outputs comprises:
providing a first detection output as a text salient map covering said each word;
providing a second detection output as a text skyline left map at a lefthand portion of each word of text;
providing a third detection output as a text skyline right map at a righthand portion of each word of text;
providing a fourth detection output as a text skyline top map at a topmost portion of each word of text; and
providing a fifth detection output as a text skyline bottom map at a left portion of each word of text.

13. The apparatus of claim 11, wherein the second plurality of detection channels comprises four second detection channels, the method further comprising:
providing a first bounding box orientation at 0 degrees with respect to a horizontal position of said each word;
providing a second bounding box orientation at 90 degrees with respect to the horizontal position of said each word;
providing a third bounding box orientation at 180 degrees with respect to the horizontal position of said each word;
providing a fourth bounding box orientation at 270 degrees with respect to the horizontal position of said each word; and
responsive to providing the first through fourth bounding box orientations, generating the plurality of possible bounding box orientations.

14. The apparatus of claim 12, wherein the second plurality of detection channels comprises four second detection channels, the method further comprising:
providing a first bounding box orientation at 0 degrees with respect to a horizontal position of said each word;
providing a second bounding box orientation at 90 degrees with respect to the horizontal position of said each word;
providing a third bounding box orientation at 180 degrees with respect to the horizontal position of said each word;
providing a fourth bounding box orientation at 270 degrees with respect to the horizontal position of said each word; and
responsive to providing the first through fourth bounding box orientations, generating the plurality of possible bounding box orientations.

15. The apparatus of claim 13, wherein the generating the plurality of possible bounding box locations further comprises:
combining the text salient map with the text skyline left map, the text skyline right map, the text skyline top map, and the text skyline bottom map, and with the word of text, to generate said each word with a remaining portion of the text salient map superimposed thereon;
determining a perimeter of the remaining portion of the text salient map; and
based on the text salient map, expanding the perimeter to generate the plurality of possible bounding box locations.

16. The apparatus of claim 14, wherein the method further comprises:
outputting a plurality of bounding boxes, each at a different respective confidence level, the method further comprising performing non-maximum suppression on each of the generated bounding boxes to facilitate combining of bounding boxes for adjacent or overlapping words; and
responsive to performing the non-maximum suppression, outputting a bounding box for said each word at the determined location.

17. The apparatus of claim 15, wherein the method further comprises:
responsive to generating the second through fifth detection outputs, outputting a preliminary orientation for each of the plurality of bounding boxes; and
responsive to the preliminary orientation, outputting the bounding box for said each word at the determined orientation and determined location.

18. The apparatus of claim 13, wherein the method further comprises:
responsive to providing said first through fourth bounding box orientations, combining the plurality of possible bounding box orientations with the preliminary orientation for said each word to output the bounding box at the determined orientation.

19. The apparatus of claim 11, wherein the deep learning system comprises a neural network having a first plurality of convolution layers, a first plurality of nonlinear layers, a first plurality of intermediate layers, and at least one first detection layer, and wherein the providing the first outputs comprises, for said first pluralities of convolution layers, nonlinear layers, and intermediate layers and said at least one first detection layer:
merging an up-sampled feature map from a first intermediate layer and an output of a first nonlinear layer and providing a first merged result to a second intermediate layer;
merging an up-sampled feature map of the first merged result from the second intermediate layer and an output of a second nonlinear layer and providing a second merged result to the third intermediate layer;
merging an up-sampled feature map of the second merged result from the third intermediate layer and an output of a third nonlinear layer and providing a third merged result to the fourth intermediate layer;
merging an up-sampled feature map of the third merged result from the fourth intermediate layer and an output of a fourth nonlinear layer and providing a fourth merged result to the fifth intermediate layer; and
merging an up-sampled feature map of the fourth merged result from the fifth intermediate layer and an output of a fifth nonlinear layer and providing a fifth merged result to the detection layer.

20. The apparatus of claim 19, wherein said neural network has a second plurality of convolution layers, a second plurality of nonlinear layers, a second plurality of intermediate layers, and at least one second detection layer, and wherein the providing the second outputs comprises, for said second pluralities of convolution layers, nonlinear layers, and intermediate layers and said at least one first detection layer:
merging an up-sampled feature map from a first intermediate layer and an output of a first nonlinear layer and providing a first merged result to a second intermediate layer;
merging an up-sampled feature map of the first merged result from the second intermediate layer and an output of a second nonlinear layer and providing a second merged result to the third intermediate layer;
merging an up-sampled feature map of the second merged result from the third intermediate layer and an output of a third nonlinear layer and providing a third merged result to the fourth intermediate layer;
merging an up-sampled feature map of the third merged result from the fourth intermediate layer and an output of a fourth nonlinear layer and providing a fourth merged result to the fifth intermediate layer; and
merging an up-sampled feature map of the fourth merged result from the fifth intermediate layer and an output of a fifth nonlinear layer and providing a fifth merged result to the detection layer.
